(19) United States
(12) Patent Application Publication
(10) Pub. No.: US 2005/0169481 A1
(43) Pub. Date: Aug. 4, 2005

(54) Method of assigning user keys for broadcast encryption

(75) Inventors: Sung-hyu Han, Seoul (KR); Yun-sang Kim, Suwon-si (KR); Yang-lim Choi, Seongnam-si (KR); Yong-kuk You, Suwon-si (KR); Hee-chul Han, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/004,932

(22) Filed: Dec. 7, 2004

(30) Foreign Application Priority Data
Feb. 2, 2004 (KR) 2004-6607

(51) Int. Cl. H04L 9/00; H04N 7/167

(52) U.S. Cl. 380/277; 713/163; 380/239

(57) ABSTRACT

A method of assigning user keys for broadcast encryption. According to the method, at least one unit tree in which grandparent nodes, parent nodes, and son nodes are hierarchically connected is created. User keys created to identify lower-level nodes connected to all nodes of the tree are assigned as first user keys of the nodes for all nodes of the tree, and node identification user keys of the son nodes except for the son node included in the unit tree among node identification user keys that identifies son nodes included in unit trees are assigned as second user keys of the son nodes.

### CROSS REFERENCE TO RELATED APPLICATION

This application claims the priority of Korean Patent Application No. 2004-6607, filed on Feb. 2, 2004, in the Korean Intellectual Property Office, the disclosure of which is incorporated herein in its entirety by reference.

### BACKGROUND OF THE INVENTION

1. Field of the Invention

The present invention relates to a method of assigning user keys, and more particularly, to a method of assigning user keys, for enabling only an authorized user to reproduce contents in contents distribution for broadcast encryption.

2. Description of the Related Art

Recently, various software data such as game programs, audio data, video data, image data, and document creation programs (hereafter, referred to as contents) have been marketed over networks like the Internet or marketable memory media such as digital versatile discs (DVDs) or compact discs (CDs). These marketed contents can be stored in recording devices included in recording and reproducing apparatuses such as personal computers (PCs) and game consoles of users, e.g., in memory cards and hard discs, and, after storage, the stored contents are available by reproduction from storage media.

The right of distribution of numerous contents such as game programs, music data, and image data is generally held by the creator and a distributor of the contents. Thus, it is a general practice regarding distribution of the contents to consider a use limit, e.g., a situation where only an authorized user is allowed to use the software and unauthorized copying is not allowed.

One method for realizing the use limit to users is to encrypt the contents to be distributed and enable only an authorized user to obtain a means for decrypting the encrypted contents. For example, encrypted contents such as encrypted audio data, image data, and game programs are distributed over the Internet and a means for decrypting the distributed encrypted contents, i.e., a contents key, is assigned only to a user who is verified as an authorized user.

The contents key should only be distributed to an authorized user. Thus, if a distributed reproducing apparatus is revoked due to illegal copying, it should no longer be regarded as an authorized user apparatus. A broadcast encryption method is one of the encryption methods for discriminating illegally copied apparatuses after a user apparatus is sold to a user.

According to the broadcast encryption method, an encryption key block including a contents key used to encrypt contents is transmitted when the contents is transmitted. The user apparatus creates a contents key using the transmitted encryption key block and its own user key block.

The broadcast encryption method can be classified into a complete subtree (CS) method, a subset difference (SD) method, and an asano method according to the way the encryption key block is created.

However, according to conventional broadcast encryption methods, a data size of the encryption key block that should be transmitted with the contents increases as the number of user nodes increases. Considering the number of actually sold user apparatuses, if the data size of the encryption key block can be reduced, contents distribution will be more simplified and network resources will be more efficiently used.

### SUMMARY OF THE INVENTION

The present invention provides a method of assigning user keys for broadcast encryption, by which a data size of an encryption key block can be reduced when contents are distributed using broadcast encryption.

According to an aspect of the present invention, there is provided a method of assigning user keys for broadcast encryption, the method including: creating a tree including at least one unit tree in which grandparent nodes, parent nodes, and son nodes are hierarchically connected; for all nodes of the tree, assigning user keys created to identify lower-level nodes connected to all nodes of the tree as first user keys of corresponding nodes; for the unit tree, among node identification user keys that identify son nodes included in unit trees, assigning node identification user keys of the other son nodes except for the corresponding son node included in the unit tree, as second user keys of the corresponding son nodes.

According to another aspect of the present invention, there is provided a method of selecting an encryption key using a tree structure, the method including: for respective nodes of the tree structure, assigning user keys created to identify lower-level nodes of a node as first user keys of the corresponding node; for unit trees as a portion of the tree where grandparent nodes, parent nodes, and son nodes are hierarchically connected, assigning node identification user keys of nodes except for the corresponding son nodes among the node identification user keys that identify the son nodes included in the unit trees, as second user keys of corresponding son nodes; among the unit trees, extracting a revoked unit tree including a single revoked user node; and among the second user keys, selecting a node identification user key that identifies the revoked user node as an encryption key.

According to still another object of the present invention, there is provided a method of distributing user keys for broadcast encryption, the method including: creating a tree including at least one unit tree in which grandparent nodes, parent nodes, and son nodes are hierarchically connected; for all nodes in the tree, assigning user keys created to identify lower-level nodes of the nodes as first user keys of corresponding nodes; for unit trees, assigning node identification user keys that identify the son nodes included in the unit trees except for the corresponding son nodes as second user keys of the corresponding son nodes; distributing the first user keys assigned to all nodes present in a route from the lowermost-level nodes of the tree to the uppermost-level nodes of the tree to user apparatuses corresponding to the lowermost-level nodes; and distributing the second user keys assigned to all unit trees including the lowermost-level nodes to user apparatuses corresponding to the lowermost-level nodes.

### BRIEF DESCRIPTION OF THE DRAWINGS

The above and other aspects and advantages of the present invention will become more apparent by describing in detail exemplary embodiments thereof with reference to the attached drawings in which:

FIG. 1 is a view for explaining a method of distributing contents according to a first embodiment of the present invention;

FIG. 2 illustrates an internal configuration of a message transmitted to a user apparatus;

FIG. 3 is a view for explaining a method of assigning user keys according to the first embodiment of the present invention;

FIG. 4 is a view for explaining creation of first user keys;

FIG. 5 illustrates the entire tree structure in which unit trees as shown in FIG. 3 are connected;

FIG. 6 is a view for explaining a method of selecting an encryption key according to the first embodiment of the present invention;

FIG. 7 is a view for explaining a conventional method of selecting an encryption key in the same tree structure as that of FIG. 6;

FIG. 8 is a view for explaining a method of selecting an encryption key according to a second embodiment of the present invention; and

FIG. 9 is a view for explaining a conventional method of selecting an encryption key in the same tree structure as that of FIG. 8.

### DETAILED DESCRIPTION OF THE INVENTION

The present invention will now be described more fully with reference to the accompanying drawings.

Terms to be used in the following description are defined as follows:

A “user key” means a key used to encrypt a contents key in a broadcast encryption method. Also, the user key is included in various forms in a user key block or an encryption key block that is distributed to respective user apparatuses.

A “user key block” means a group of user keys stored in a user apparatus during the manufacture of the user key apparatus.

An encryption key block means a group of contents keys encrypted using the user keys so an encryption center may allow only an authorized user apparatus to decrypt the encoded contents keys. The user keys are selected as various forms depending on a broadcast encryption method and the present invention is one of the various forms.

A “user node” means the lowermost node among nodes included in a tree structure used for user key assignment in a broadcast encryption method. Also, the user node specifies the user apparatus.

A “grandparent node” means the uppermost node in a tree structure, a parent node means all lower nodes connected to one grandparent node, and a son node means all lower nodes connected to the parent nodes connected to one grandparent node.

A “message” means data sent from the encryption center to the user apparatus and includes encrypted contents and the encryption key block.

A “revoked user” apparatus means an apparatus that is initially an authorized user apparatus during the manufacture and disqualified as an authorized user apparatus later due to illegal copying. The revoked user apparatus cannot obtain the contents keys from its own user key block.

An “encryption key” means a user key used to create the encryption key block and is changed by the encryption center whenever the revoked user apparatus is found.

“To cover” means to assign the encryption key to allow an authorized user except for the revoked user apparatus to obtain the contents keys when the encryption key is selected using the tree structure.

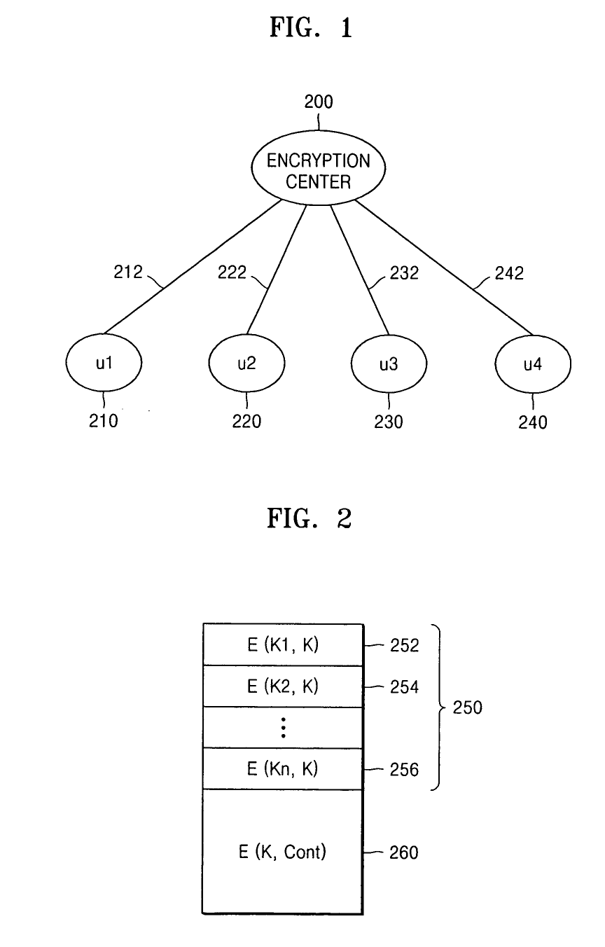

FIG. 1 is a view for explaining an exemplary method of distributing contents according to a first embodiment of the present invention.

Referring to FIGS. 1 and 2, an encryption center 200 distributes encrypted contents to user apparatuses 210, 220, 230, and 240 using a contents key Kt. At this time, the contents key Kt is encrypted using a plurality of user keys K1, K2, and encrypted contents keys E(K1, Kt), E(K2, Kt), E(K3, Kt) . . . are transmitted to the user apparatuses 210, 220, 230, and 240 in forms of encryption key blocks 212, 222, 232, and 242.

The user apparatuses 210, 220, 230, and 240 include user key blocks, respectively. The user key blocks include the user keys K1, K2, . . . , respectively, that are assigned according to a predetermined user key assigning method. The assigned user keys K1, K2, . . . are previously stored in the user apparatuses 210, 220, 230, and 240 during the manufacture of the user apparatuses 210, 220, 230, and 240. After the user apparatuses 210, 220, 230, and 240 are sold to users, the user keys K1, K2, . . . cannot be changed by the users.

FIG. 2 illustrates an internal configuration of a message transmitted to each of the user apparatuses 210, 220, 230, and 240 of FIG. 1. The message includes a contents E(Kt, Cont) 260 that is encrypted using the contents key Kt and an encryption key block 250. The encryption key block 250 includes the contents keys E(K1, Kt), E(K2, Kt), E(K3, Kt), . . . that are encrypted using the user keys K1, K2, . . . . The encryption key block 250 is changed by the encryption center 200 (FIG. 1) whenever a revoked user apparatus is found, and the changed encryption key block is distributed to the user apparatuses 210, 220, 230, and 240.

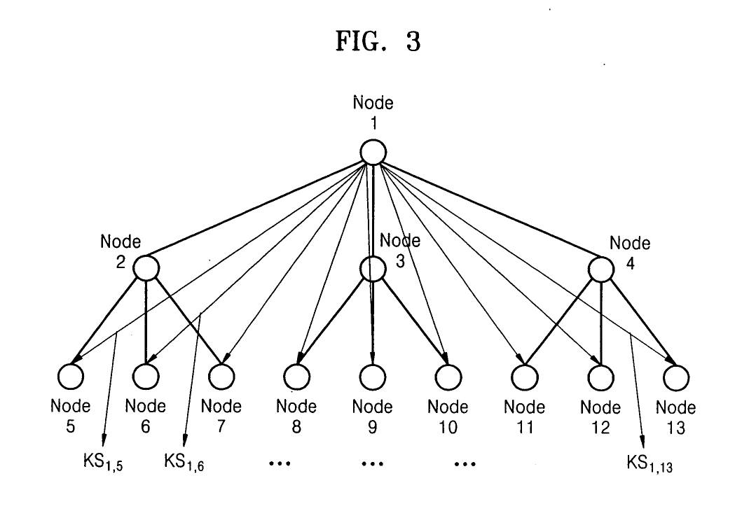

Hereinafter, an exemplary method of distributing user keys according to the present invention will be described with reference to FIGS. 3 through 5.

FIG. 3 is a view for explaining a method of assigning user keys according to the first embodiment of the present invention.

A tree as shown in FIG. 3 includes three-level nodes. Here, a level indicates an order of a node in a hierarchical structure. For example, in FIG. 3, a node 1 is at a first level of the tree, nodes 2 through 4 are at a second level of the tree, and nodes 5 through 13 are at a third level of the tree. The lowermost nodes 5 through 13 indicate user nodes.

A method of distributing user keys according to the present invention comprises a first step of assigning first user keys and a second step of assigning second user keys.

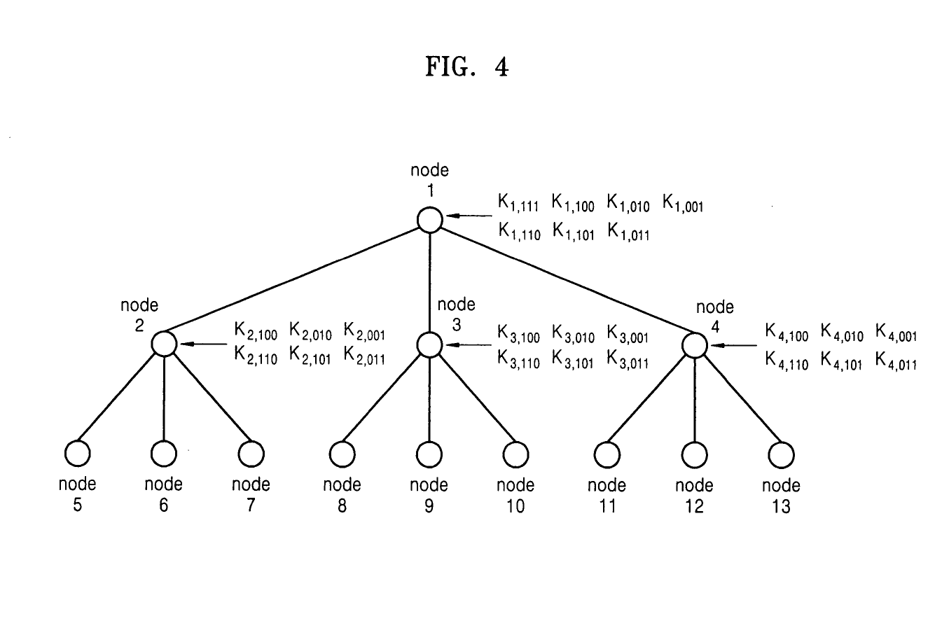

Hereinafter, a method of creating the first user keys will be explained with reference to FIG. 4.

FIG. 4 is a view for explaining a method of assigning the first user keys.

A user key block transmitted to user apparatuses includes a plurality of user keys and the user keys are assigned to each of the user apparatuses through a tree-like structure as shown in FIG. 4. In the tree-like structure, a plurality of nodes is hierarchically connected. The method of FIG. 4 is often called an asano method. In the tree-like structure according to the asano method, three child nodes are connected to each parent node and a plurality of user keys is assigned to each node. The method of assigning user keys is as below.

First, 6 user keys (K_{N,XYZ}), e.g., K_{1,100},K_{1,010}, K_{1,001}, K_{1,110}, K_{1,101}, and K_{1,011}, are assigned to every node. Here, a subscript N (1, 2, 3 . . . ) indicates a node number to which user keys are assigned, and subscripts (XYZ), e.g., 111, 100, . . . indicate keys that can cover nodes except for revoked child nodes among child nodes connected to parent nodes. For example, K_{1,110} indicates a key that can cover all user apparatuses at left-side child nodes and middle child nodes among the left-side child nodes, middle child nodes, and right-side child nodes below the node 1. Here, a verb “cover” indicates providing a means for allowing non-revoked apparatuses to obtain a contents key.

Also, one user key such as K_{1,111} is additionally assigned to the node 1 that is a root node. Since the root node does not have any upper-level node, it should have a user key used to identify itself.

In the method illustrated in FIG. 4, the contents key is only provided to non-revoked user apparatuses except for revoked user apparatuses, as follows.

A first step is to distribute a user key block during the manufacture of a user apparatus. According to the method described above, among user keys assigned to respective nodes, user keys related to user nodes at the lowermost level of a tree structure are assigned to corresponding user nodes. As a result, user apparatuses corresponding to the corresponding user nodes have a user key block including the assigned user keys. For example, in FIG. 4, a user apparatus corresponding to a node 5 has a user key block composed of a total of 7 user keys, e.g., K_{1,111}, K_{1,100}, K_{1,101}, K_{1,110}, K_{2,100}, K_{2,110}, and K_{2,101}, and a user apparatus corresponding to a node 9 has a user key block composed of a total of 7 user keys, e.g., K_{1,111}, K_{1,011}, K_{1,010}, K_{1,110}, K_{3,010}, K_{3,011}, and K_{3,110}. In general, a user key block is previously stored in a user apparatus during the manufacture of the user apparatus, is distributed to a user, and is not changed after distribution.

A second step is to distribute an encryption key block when a revoked user apparatus is found.

First, keys that cover non-revoked user nodes are selected from among user keys assigned to all nodes that include revoked user nodes as their lower-level nodes. For example, if nodes 5 and 9 are revoked in the tree structure of FIG. 4, K_{1,001} is selected from among user keys assigned to the node 1, K_{2,001} is selected from among user keys assigned to the node 2, and K_{3,101} is selected from among user keys assigned to the node 3.

Thereafter, an encryption key block including contents keys encrypted using the selected user keys and contents encrypted by the contents keys are transmitted to all user apparatuses. All user apparatuses receive the encryption key block and the encrypted contents, but the contents key that can decrypt the contents is encrypted using only the selected user keys. Thus, the revoked user apparatus does not have the user key used to decrypt the encrypted contents keys. As a result, only the non-revoked user apparatuses can obtain the contents keys and reproduce the contents.

For example, if the nodes 5 and 9 are revoked user apparatuses, the encryption key block transmitted to all user apparatuses is composed of contents keys E(K_{1,001}, Kt), E(K_{2,001}, Kt), and E(K_{3,101}, Kt) that are products of encrypting the contents key Kt using user keys K_{1,001}, K_{2,011}, and K_{3,101}. As a result, since the user keys K_{1,001}, K_{2,011} and K_{3,101} are not present in user key blocks owned by the user apparatuses corresponding to the nodes 5 and 9, the user apparatuses corresponding to the nodes 5 and 9 cannot obtain the contents key Kt. Since the user apparatuses corresponding to the nodes 6 and 7 do not have a user key block including the user key K_{2,011}, the user apparatuses corresponding to the nodes 8 and 10 do not have a user key block including the user key K_{3,101}, and the user apparatuses corresponding to the nodes 11, 12, and 13 do not have a user key block including the user key K_{1,001}, the user apparatuses corresponding to the nodes 6, 7, 8, 10, 11, 12, and 13 all can obtain the contents key Kt.

Referring back to FIG. 3, when the first user keys are created, all nodes included in the tree structure have user keys assigned in the same way as in FIG. 4. Thus, the user keys K_{1,001}, K_{1,010}, K_{1,100}, K_{1,011}, K_{1,110}, K_{1,101}, and K_{1,111} are assigned to the node 1, user keys K_{2,001}, K_{2,010}, K_{2,100}, K_{2,011}, K_{2,110}, and K_{2,101} are assigned to the node 2, user keys K_{3,001}, K_{3,010}, K_{3,100}, K_{3,011}, K_{3,110}, and K_{3,101} are assigned to the node 3, and user keys K_{4,001}, K_{4,010}, K_{4,100}, K_{4,011}, K_{4,110}, and K_{4,101} are assigned to the node 4.

In FIG. 3, since the nodes 5 through 13 are user nodes, no user key is assigned to them. However, if the tree structure includes more than four-level nodes and the nodes 5 through 13 are not user nodes, user keys are assigned to the nodes 5 through 13 in the method described above. The user keys assigned in the first step are defined as the first user keys.

Hereinafter, a method of creating the second user keys will be explained with reference to FIG. 3.

In creating the second user keys, the second user keys are assigned to all son nodes included in one unit tree. The second user keys are defined by a relationship between grandparent nodes and son nodes in one unit tree. In other words, the second user keys are defined as node identification user keys except for a node identification user key for identifying a corresponding son node included in one grandparent node.

For example, the node identification user keys of the son nodes 5 through 13 in the unit tree of FIG. 4 are S_{1,5}, S_{1,6}, S_{1,7}, S_{1,8}, S_{1,9}, S_{1,10}, S_{1,11}, S_{1,12}, and S_{1,13}. Thus, S_{1,6}, S_{1,7}, S_{1,8}, S_{1,9}, S_{1,10}, S_{1,11}, S_{1,12}, and S_{1,13} are assigned to the node 5, S_{1,5}, S_{1,7}, S_{1,8}, S_{1,9}, S_{1,10}, S_{1,11}, S_{1,12}, and S_{1,13} are assigned to the node 6, S_{1,5}, S_{1,6}, S_{1,8}, S_{1,9}, S_{1,10}, S_{1,11}, S_{1,12}, and S_{1,13} are assigned to the node 7, S_{1,5}, S_{1,6}, S_{1,7}, S_{1,9}, S_{1,10}, S_{1,11}, S_{1,12}, and S_{1,13} are assigned to the node 8, S_{1,5}, S_{1,6}, S_{1,7}, S_{1,8}, S_{1,10}, S_{1,11}, S_{1,12}, and S_{1,13} are assigned to the node 9, and, in this way, S_{1,5}, S_{1,6}, S_{1,7}, S_{1,8}, S_{1,9}, S_{1,10}, S_{1,11}, and S_{1,12} are assigned to the node 13. Here, a subscript 1 means the uppermost-level node number of the tree including a corresponding node and subscripts 5 through 13 mean a node number of a node to which user keys are assigned.

The tree of FIG. 3 will be defined as a unit tree. In other words, the unit tree is a portion of the entire tree having a predetermined number of parent nodes and son nodes that are connected below one grandparent node. The number of parent nodes and son nodes may vary according to the number of levels of a unit node. The tree of FIG. 3 shows a unit node in which there are three lower-level nodes with respect to one upper-level node and the number of predetermined levels in a unit tree is 3.

A group of the second user keys assigned to each node is defined as a second user key set. For example, with respect to the node structure shown in FIG. 4, KS_{1,5} (not shown) indicates {S_{1,6}, S_{1,7}, S_{1,8}, S_{1,9}, S_{1,10}, S_{1,11}, S_{1,12}, and S_{1,13}} and KS_{1,7} indicates {S_{1,5}, S_{1,6}, S_{1,8}, S_{1,9}, S_{1,10}, S_{1,11}, S_{1,12}, and S_{1,13}}.

The number of user keys included in the second user key set assigned to each node is B^{N-1}-1. Here, B indicates the number of lower-level nodes connected to one upper-level node and N indicates the number of levels included in one unit tree. For example, the number of user keys included in a single second user key set in the unit tree of FIG. 4 is 3³⁻¹−1=8.

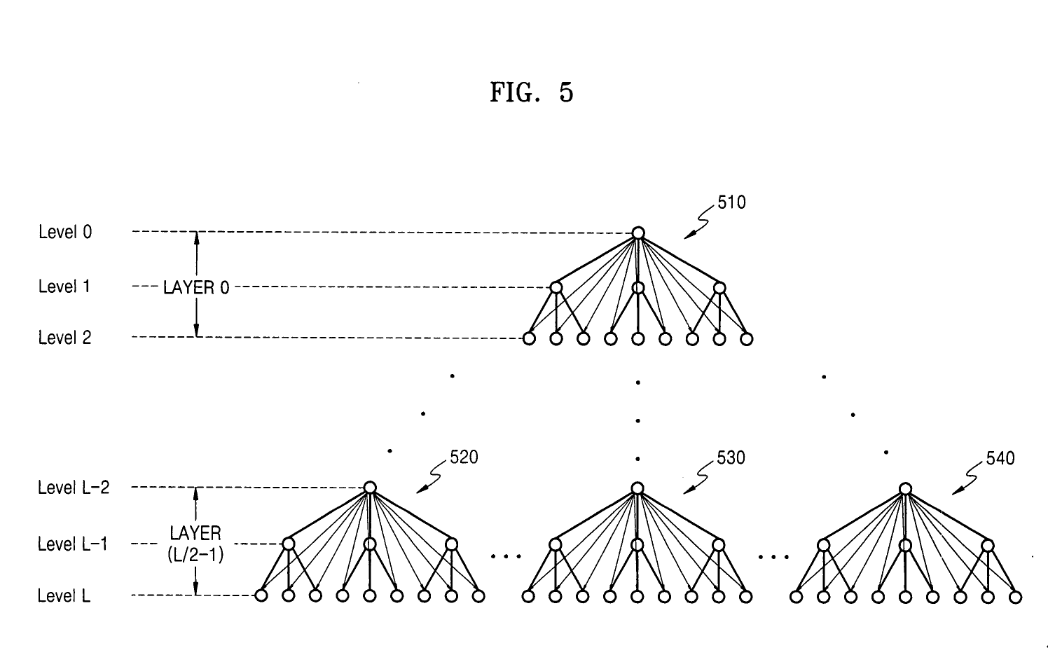

FIG. 5 illustrates the entire tree structure in which unit trees as shown in FIG. 3 are connected.

If the nodes 5 through 9 of FIG. 3 are not the lowermost-level nodes, i.e., the user nodes, the nodes 5 through 9 have new unit trees below them and thus become grandparent nodes of new unit nodes.

The entire tree structure includes at least one unit tree 510, 520, 530, 540, In FIG. 4, one unit tree extends over three levels. A layer is defined as a group of levels forming a unit tree. In FIG. 5, a layer 0 extends over levels 0 through 2, a layer 1 extends over levels 2 through 4, and, in this way, a layer R extends over levels L-2 through L. Here, L denotes a level number and is equal to N+1, and R denotes a layer number and is equal to L/2−1.

In FIG. 5, one unit tree extends over three levels and three levels form one layer. Thus, one unit tree is present in one layer. However, the number of unit trees included by one layer varies according to a layer and is equal to B^{2R}.

According to the entire tree structure of FIGS. 3 and 5, the first user keys created according to the method of FIG. 4 are assigned to all nodes included in the entire tree structure and the second user keys created according to the method of FIG. 3 are assigned to every unit tree. The lowermost-level nodes in the entire tree structure, i.e., the user nodes, have the first user keys assigned to all nodes present in a route from the user nodes to the uppermost-level nodes and the second user keys assigned to all unit trees including the user nodes. In other words, the user apparatuses corresponding to the user nodes store the encryption key block including the first user keys and the second user keys during the manufacture of the user apparatuses.

Here, ‘all unit trees including the user nodes’ means unit trees including corresponding user nodes and all unit trees connected to the unit trees in an upper layer.

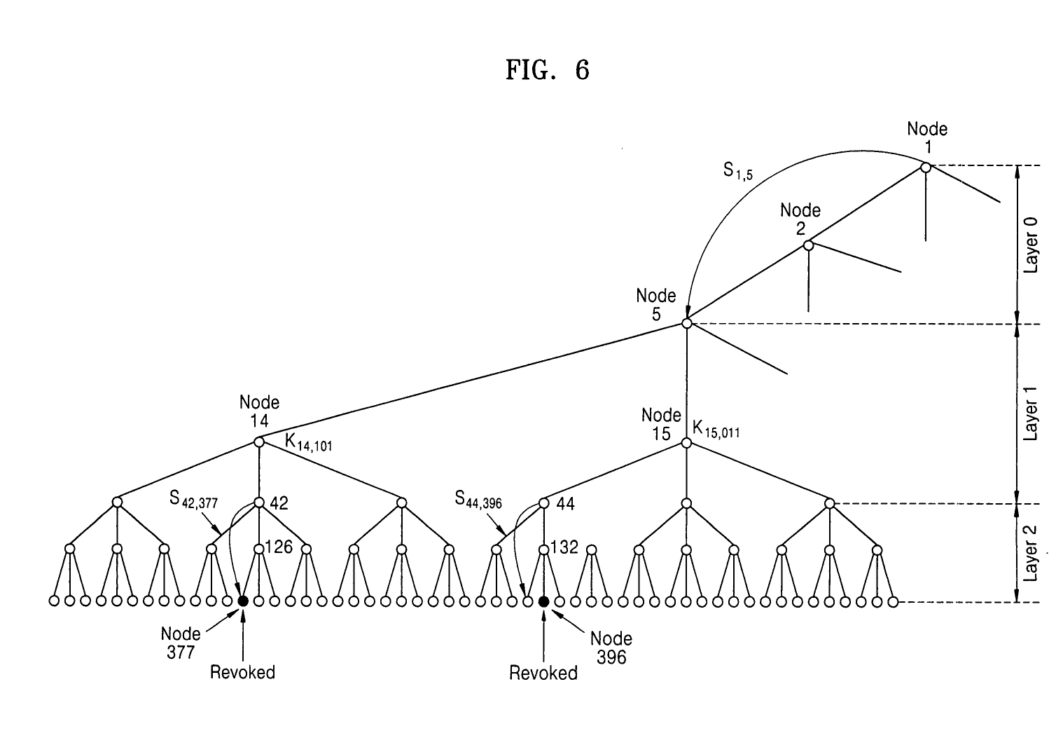

Hereinafter, a method of creating an encryption key block when a revoked user apparatus is found will be described with reference to FIGS. 6 through 9.

FIG. 6 is a view for explaining an exemplary method of selecting an encryption key according to the first embodiment of the present invention.

Selection of the encryption key should be performed in the way that the encryption center can cover all user apparatuses except for revoked user apparatuses.

The tree of FIG. 6 is composed of seven levels (levels 0 through 6), three layers (layers 0 through 2), and revoked user nodes 377 and 396. For conveniences of explanation, unit trees 1, 5, 41, 42, 43, 44, 45, and 46 are defined as unit trees having grandparent nodes 1, 5, 41, 42, 43, 44, 45, and 46, respectively.

Hereinafter, user keys assigned to the revoked user nodes 377 and 396 will be explained.

The first user keys assigned to the node 377 are related to the location of the node 377 among the first user keys assigned to the nodes 126, 42, 14, 5, 2, and 1. In other words, the first user keys assigned to the node 377 are K_{126,100}, K_{126,110}, K_{126,101}, K_{42,010}, K_{42,110}, K_{42,011}, K_{14,010}, K_{14,110}, K_{14,011}, K_{5,100}, K_{5,110}, K_{5,101}, K_{2,100}, K_{2,110}, K_{2,101}, K_{1,100}, K_{1,110}, K_{1,101}, and K_{1,111}.

Also, since the second user key set assigned to the node 377 includes KS_{42,377} and KS_{1,5}, the second user keys assigned to the node 377 are KS_{42,377}={S_{42,374}, S_{42,375}, S_{42,376}, S_{42,378}, S_{42,379}, S_{42,380}, S_{42,381}, and S_{42,382}} and KS_{1,5}={S_{1,6}, S_{1,7}, S_{1,8}, S_{1,9}, S_{1,10}, S_{1,11}, S_{1,12} and S_{1,13}}.

Similarly, the first user keys assigned to the node 396 are related to the location of the node 396 among the first user keys assigned to the nodes 132, 44, 15, 5, 2, and 1. In other words, the first user keys assigned to the node 396 are K_{132,010}, K_{132,011}, K_{132,110}, K_{44,010}, K_{44,110}, K_{44,011}, K_{15,100}, K_{15,110}, K_{15,101}, K_{5,100}, K_{5,110}, K_{5,101}, K_{2,100}, K_{2,110}, K_{2,101}, K_{1,100}, K_{1,110}, K_{1,101}, and K_{1,111}.

Also, since the second user key set assigned to the node 396 includes KS_{44,396} and KS_{1,5}, the second user keys assigned to the node 396 are KS_{44,396}={S_{44,392}, S_{44,393}, S_{44,394}, S_{44,395}, S_{44,397}, S_{44,398}, S_{44,399}, and S_{44,400}} and KS_{1,5}={S_{1,6}, S_{1,7}, S_{1,8}, S_{1,9}, S_{1,10}, S_{1,11}, S_{1,12} and S_{1,13}}.

Hereinafter, a method of selecting user keys used for encryption key block creation will be described.

Since the user nodes 377 and 396 are revoked, the encryption key block distributed by the encryption center should include contents keys encrypted using user keys that are not included in the nodes 377 and 396. In other words, the user key used for creation of the encryption key block should cover all nodes excluding the user keys owned by the nodes 377 and 396.

In the layer 0, the user key S_{1,5} can cover all user nodes except for user nodes below the node 5.

In the layer 1, the user key K_{5,001} can cover all user nodes below the node 16 among the user nodes below the node 5.

In the layer 1, the user key K_{14,101} can cover all user nodes below the nodes 41 and 43, i.e., the nodes 365 through 373 and the nodes 383 through 391.

In the layer 1, the user key K_{15,011} can cover all nodes below the nodes 45 and 46, i.e., the nodes 401 through 418.

In the layer 2, the user key S_{42,377} can cover all nodes among the node 42 except for the node 377, i.e., the nodes 374, 375, 376, 378, 379, 380, 381, and 382.

In the layer 2, the user key S_{44,396} can cover all nodes below the node 44 except for the node 396, i.e., the nodes 392, 393, 394, 395, 397, 398, 399, and 400.

The user keys that cover all nodes in the entire tree except for the revoked user nodes 377 and 396 are S_{1,5}, K_{5,001}, K_{14,101}, K_{15,011}, S_{42,377}, and S_{44,396}. Thus, the encryption key block transmitted to the user apparatus by the encryption center is composed of the contents keys encrypted using 6 user keys S_{1,5}, K_{5,001}, K_{14,101}, K_{15,011}, S_{42,377}, and S_{44,396}.

A method of selecting an encryption key can be generalized as follows.

First, a revoked unit tree is extracted. Here, the revoked unit tree indicates i) a unit tree including only a single revoked user node or ii) a unit tree including as a lower-level tree only a single unit tree having a single revoked user node. Thus, in FIG. 6, unit trees 1, 42, and 44 are revoked unit trees and unit trees 5, 41, 43, 45, 46, . . . are non-revoked unit trees.

Then, among the second user keys assigned to the revoked unit tree, i) revoked user nodes or ii) node identification user keys that identify nodes having lower-level revoked user nodes are selected as user keys to be used for encryption key block creation. In FIG. 6, S_{1,5}, S_{42,377}, and S_{44,396} are selected as user keys to be used for encryption key block creation. This is because the nodes 377 and 396 are revoked user nodes, the node identification user keys that identify the nodes 377 and 396 are S_{42,377} and S_{44,396}, the node 5 includes the revoked user nodes below itself, and thus the node identification user key that identifies the node 5 is S_{1,5}.

Among the first user keys assigned to each node in the tree, the first user keys that can cover user nodes that are not covered by the second user keys selected in the previous step are selected.

In FIG. 6, the remaining user nodes that are not covered are all user nodes below the nodes 41, 43, 45, 46, 47, 48, and 49. According to the asano method, among the first user keys assigned according to the method of FIG. 4, the first user key K_{5,001} can cover all user nodes below the nodes 47, 48, and 49, the first user key K_{14,101} can cover all user nodes below the nodes 41 and 43, and the first user key K_{15,011} can cover all user nodes below the nodes 45 and 46. Thus, K_{5,001}, K_{14,101}, and K_{15,011} are selected as user keys to be used for creation of the encryption key block.

The selected user key is used for encryption of the contents keys. The contents keys encrypted by the selected user keys form the encryption key block and are transmitted to the user apparatuses corresponding to the user nodes in the tree.

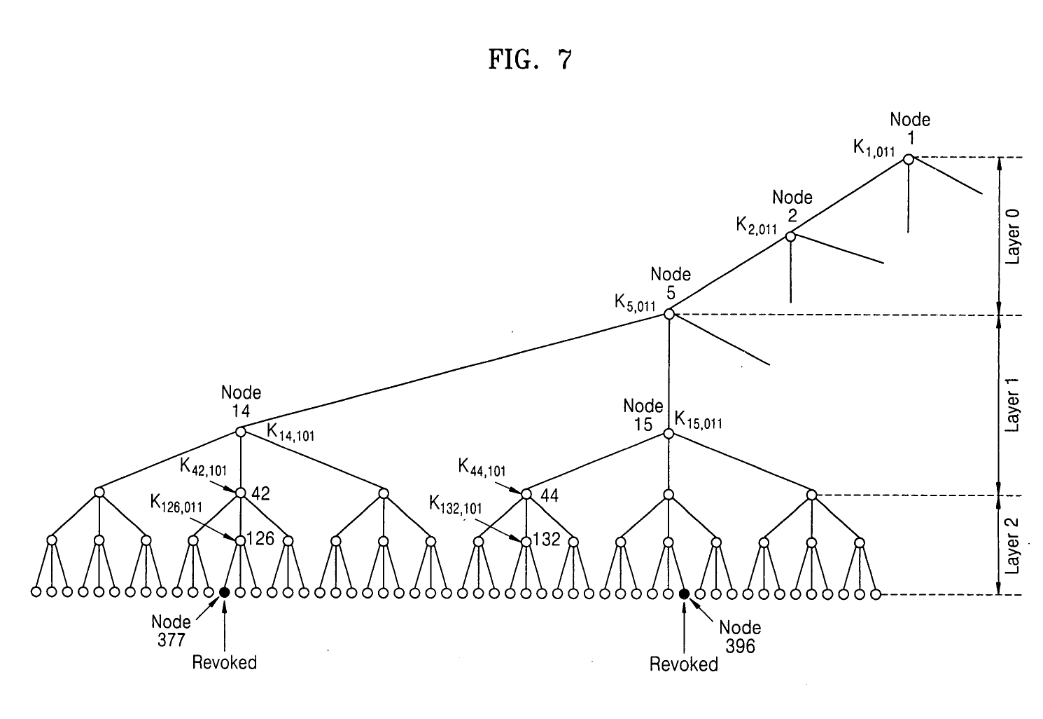

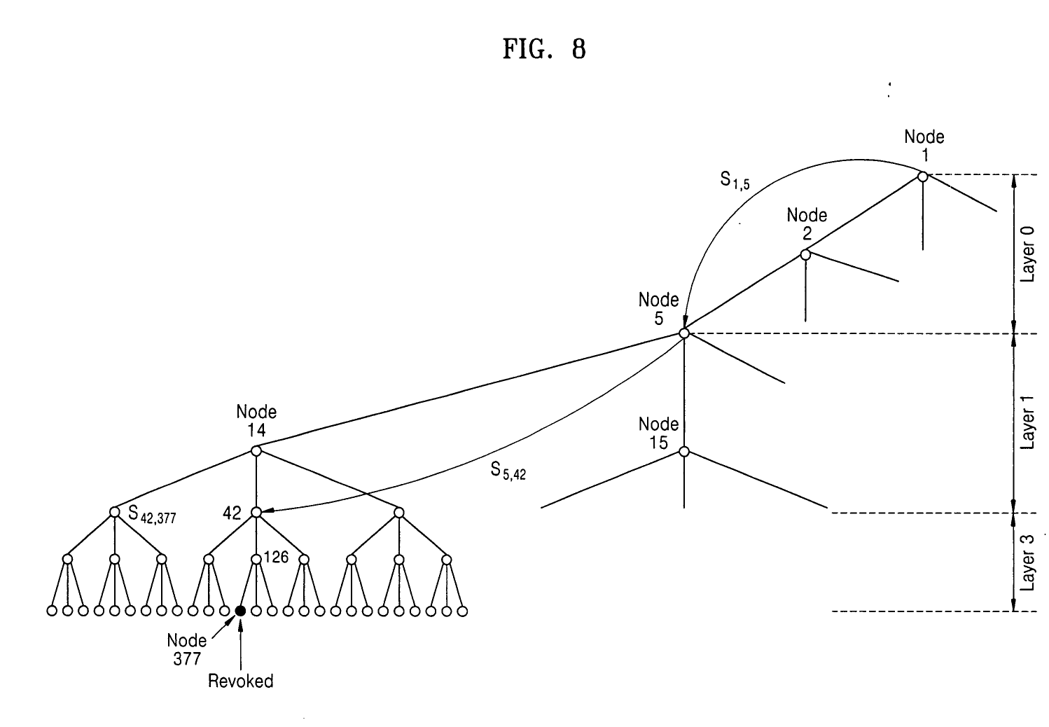

FIG. 7 is a view for explaining a conventional method of selecting an encryption key in the same tree structure as that of FIG. 6.

As shown in FIG. 7, according to the conventional method, the encryption key block is created using only the first user keys. Thus, to cover all non-revoked nodes in the entire tree using the conventional method, a total of 9 user keys, i.e., K_{1,011}, K_{2,011}, K_{5,001}, K_{14,101}, K_{15,011}, K_{42,101}, K_{44,101}, K_{126,011}, and K_{132,101}, are required. The number of required user keys according to the conventional method is greater by 3 than the number of user keys required for encryption key block creation according to the method of selecting the user keys of the present invention. Therefore, according to the present invention, the number of encrypted contents keys included in the encryption key block is reduced to 6, thus reducing a message size.

FIG. 8 is a view for explaining a method of selecting an encryption key according to a second embodiment of the present invention.

Unlike the tree of FIG. 6, a tree of FIG. 8 includes a single revoked user node 377. User keys selected by using the method of FIG. 6 are S_{1,5}, S_{5,42}, and S_{42,377}. This is because the node 15 does not include any revoked user node, unlike FIG. 6, and can cover the nodes below the remaining nodes 41, 43, 44, 45, . . . except for the nodes below the node 42, among all user nodes below the node 5.

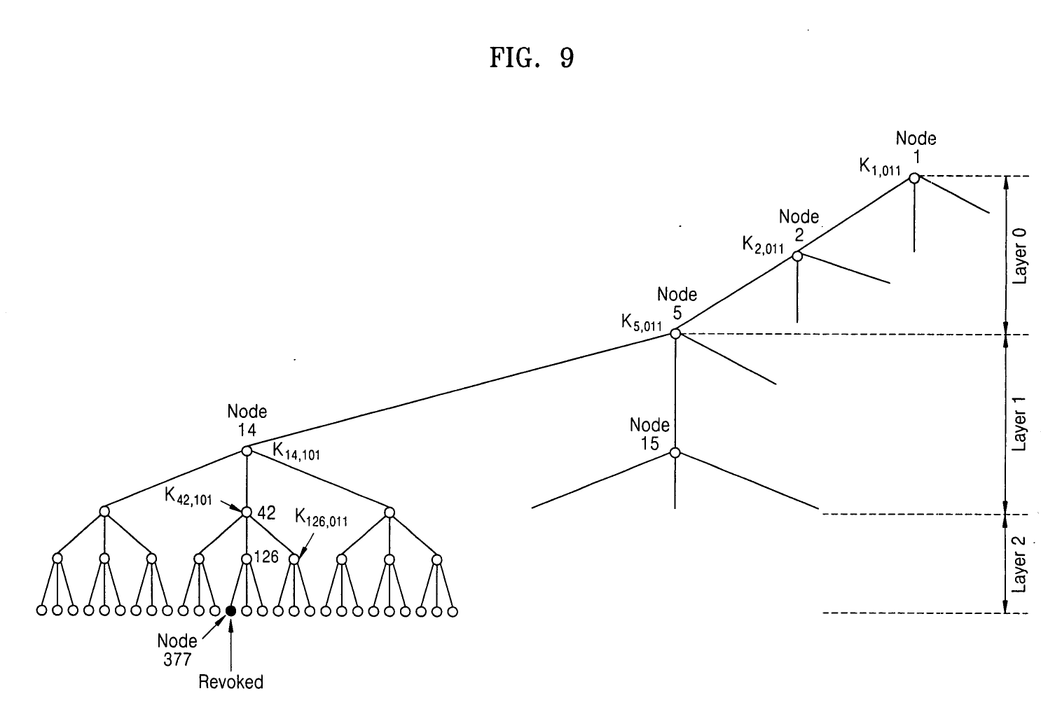

FIG. 9 is a view for explaining a conventional method of selecting an encryption key in the same tree structure as that of FIG. 8.

As shown in FIG. 9, in the case of the tree of FIG. 8, to create the encryption key block according to the conventional method, a total of 6 user keys, i.e., K_{1,011}, K_{2,011}, K_{5,011}, K_{14,101}, K_{42,101}, and K_{126,011} are required. However, as shown in FIG. 8, according to the present invention, only three user keys are used for encryption key creation, a message size can be reduced by 1/2.

The method of assigning user keys and the method of selecting the encryption key can also be embodied as computer programs. Codes and code segments forming the programs can be easily constructed by computer programmers in this field. Also, the computer programs are stored in computer readable recording media and are read and implemented by computers, thereby realizing assignment of user keys and selection of encryption keys. The computer readable media include magnetic recording media, optical recording media, and carrier waves.

As described above, the method of assigning user keys according to the present invention can reduce the number of encryption keys created by assigning only a single key to a unit tree including a single revoked node.

Also, the size of an encryption key block transmitted to each user apparatus by the encryption center is reduced, thereby effectively using network resources.

The present invention can be applied toga broadcast encryption method and a method of distributing contents using broadcast encryption.

While the present invention has been particularly shown and described with reference to exemplary embodiments thereof, it will be understood by those of ordinary skill in the art that various changes in form and details may be made therein without departing from the spirit and scope of the invention as defined by the appended claims and their equivalents.

1. A method of assigning user keys for broadcast encryption, the method comprising:
creating a main tree including at least one unit tree in which grandparent nodes, parent nodes, and son nodes are hierarchically connected;
for all nodes of the main tree, assigning user keys created to identify lower-level nodes connected to all nodes of the main tree as first user keys of corresponding nodes;
for at least one unit tree, among node identification user keys that identify son nodes included in at least one unit tree, assigning node identification user keys of the other son nodes except for the corresponding son node included in the at least one unit tree, as second user keys of the corresponding son nodes.

2. The method of claim 1, wherein in the assignment of the first user keys, the user keys are assigned based on the location of the lower-level nodes connected to all nodes.

3. The method of claim 1, wherein in the assignment of the first user keys, the user keys are assigned based on the number of lower-level nodes connected to all nodes.

4. The method of claim 3, wherein the number of lower-level nodes is 3.

5. The method of claim 4, wherein the assignment of the first user keys comprises:
creating the first user keys that indicate the lower-level nodes that are present on the left side of the unit trees;
creating the first user keys that indicate the lower-level nodes that are present on the right side of the unit trees;
creating the first user keys that indicate the lower-level nodes that are present in the middle of the unit trees;
creating the first user keys that indicate the lower-level nodes that are present on the left side of the unit trees and in the middle of the unit trees;
creating the first user keys that indicate the lower-level nodes that are present in the middle of the unit trees and on the right side of the unit trees; and
creating the first user keys that indicate the lower-level nodes that are present on the left side of the unit trees and the right side of the unit trees.

6. The method of claim 1, wherein the assignment of the second user keys comprises:
for all son nodes included in one unit tree, creating the node identification user keys that identify the son nodes; and
for every son node, assigning the node identification user keys of the son nodes except for the corresponding son nodes as the second user keys of the corresponding son nodes.

7. A method of selecting an encryption key using a tree structure, the method comprising:
for respective nodes of the tree structure, assigning user keys created to identify lower-level nodes corresponding to a specific node as first user keys of the corresponding node;
for unit trees as a portion of the tree where grandparent nodes, parent nodes, and son nodes are hierarchically connected, assigning node identification user keys of corresponding nodes except for the corresponding son nodes among the node identification user keys that identify the son nodes included in the unit trees, as second user keys of corresponding son nodes;
among the unit trees, extracting a revoked unit tree including a single revoked user node; and
among the second user keys, selecting a node identification user key that identifies the revoked user node as an encryption key.

8. The method of claim 7, wherein the extraction of the revoked unit tree comprises extracting a unit tree that includes a single unit tree having the single revoked user node as a lower-level tree.

9. The method of claim 8, wherein the selection of the node identification user key comprises selecting a node identification key that identifies a node including the revoked user node as a lower-level node, from among the second user keys.

10. The method of claim 7, further comprising selecting a first user key that can cover user nodes that are not covered by the selected second user keys, from among the first user keys.

11. The method of claim 10, wherein the selection of the first user keys comprises selecting a first user key assigned to the unit trees except for the revoked unit tree, from among the first user keys.

12. The method of claim 7, wherein the tree structure has three lower-level nodes with respect to one upper-level node.

13. The method of claim 12, wherein each of the unit trees has one grandparent node, one parent node, and one son node.

14. A method of distributing user keys for broadcast encryption, the method comprising:
creating a main tree including at least one unit tree in which grandparent nodes, parent nodes, and son nodes are hierarchically connected;
for all nodes in the main tree, assigning user keys created to identify lower-level nodes as first user keys of corresponding nodes;
for unit trees, assigning node identification user keys that identify the son nodes included in the unit trees except for the corresponding son nodes as second user keys of the corresponding son nodes;
distributing the first user keys assigned to all nodes present in a route from the lowermost-level nodes of the main tree to the uppermost-level nodes of the main tree to user apparatuses corresponding to the lowermost-level nodes; and
distributing the second user keys assigned to all unit trees including the lowermost-level nodes to user apparatuses corresponding to the lowermost-level nodes.

15. The method of claim 14, wherein the distribution of the second user keys comprises:
distributing second user keys assigned to unit trees directly including the lowermost-level nodes to the user apparatuses; and
distributing second user keys assigned to all upper-level unit trees connected to the unit trees to the user apparatuses.

16. The method of claim 8, wherein in the assignment of the first user keys, the user keys are assigned based on the location of the lower-level nodes connected to the nodes.

17. The method of claim 8, wherein in the assignment of the first user keys, the user keys are assigned based on the number of lower-level nodes connected to the nodes.

18. The method of claim 8, wherein the assignment of the second user keys comprises:
for all son nodes included in one unit tree, creating node identification user keys that identify the son nodes; and
for every son node, assigning node identification user keys of the son nodes except for the corresponding son nodes as the second user keys of the corresponding son nodes.

19. A computer readable medium having embodied thereon a computer program for a method of any one of claims 1, 7 and 14.
